(19) United States
(12) Patent Application Publication
(10) Pub. No.: US 2014/0186703 A1
(43) Pub. Date: Jul. 3, 2014

(54) POSITIVE ELECTRODE FOR POWER STORAGE DEVICE AND POWER STORAGE DEVICE

(71) Applicant: NITTO DENKO CORPORATION, Osaka (JP)

(72) Inventors: Yohei ANDO, Osaka (JP); Hiroyoshi TAKE, Osaka (JP); Aimi MATSUURA, Osaka (JP); Masao ABE, Osaka (JP); Yoshihiro UETANI, Osaka (JP)

(73) Assignee: NITTO DENKO CORPORATION, Osaka (JP)

(21) Appl. No.: 14/140,217

(22) Filed: Dec. 24, 2013

(30) Foreign Application Priority Data
Dec. 28, 2012 (JP) 2012-287151

(51) Int. Cl. H01M 4/60; H01M 4/62

(52) U.S. Cl. CPC H01M 4/606; H01M 4/622
USPC 429/213; 252/511; 528/422

(57) ABSTRACT

Provided is a positive electrode for a power storage device, which has an excellent discharge characteristic irrespective of an oxidized state of polyaniline as a positive active material and which is excellent in storability and handleability. The positive electrode for a power storage device includes polyaniline, where a ratio of a polyaniline oxidized body in the positive electrode is 0.01 to 75% to the entire polyaniline.

This application claims priority from JP 2012-287151 filed Dec. 28, 2012, the contents of which are incorporated herein by reference.

### BACKGROUND OF THE INVENTION

1. Field of the Invention

The present invention relates to a positive electrode for a power storage device, and a power storage device using the same.

2. Description of the Related Art

Recently, with the advancement and development of electronic techniques in portable personal computers, mobile phones, personal digital assistants (PDAs) and the like, secondary batteries, etc. capable of being repeatedly charged/discharged have been widely used as power storage devices of these electronic equipments. In these electrochemical power storage devices, such as secondary batteries, it is desired to enhance the capacity of a material that is used as an electrode.

The electrode of the power storage device contains an active material having a function capable of inserting/extracting ions. The insertion/extraction of ions of an active material is also referred to as so called doping/dedoping, the doping/dedoping amount per certain molecular structure is called a dope rate (or a doping rate), and a material having a higher dope rate allows a battery to have a higher capacity.

From an electrochemical standpoint, the capacity of a battery can be enhanced by using as an electrode a material with a large amount of ions inserted/extracted. More specifically, in a lithium ion secondary battery (hereinafter, abbreviated as a “lithium secondary battery”) which has received attention as a power storage device, a graphite-based negative electrode capable of inserting/extracting lithium ions is used, and about one lithium ion is inserted/extracted per six carbon atoms, so that a high capacity is achieved.

Among those lithium secondary batteries, lithium secondary batteries, in which a lithium-containing transition metal oxide such as lithium manganate or lithium cobaltate is used for a positive electrode, a carbon material capable of inserting/extracting lithium ions is used for a negative electrode, and both the electrodes are made to face each other in an electrolytic solution, have a high energy density, and are therefore widely used as power storage devices of the electronic equipments described above.

However, the lithium secondary battery described above is a secondary battery which produces electric energy through an electrochemical reaction, and has the disadvantage that the power density is low because the rate of the electrochemical reaction is low. Further, since the internal resistance of the secondary battery is high, rapid discharge is difficult, and rapid charge is also difficult. Further, since an electrode and an electrolytic solution are degraded due to an electrochemical reaction associated with charge/discharge, generally the battery life, i.e., the cycle characteristic is not good.

A lithium secondary battery is also known in which a conductive polymer such as polyaniline having a dopant is used as a positive electrode active material for improving the above-described problems (see JP-A-H03-129679).

Generally, however, a secondary battery having a conductive polymer as a positive electrode active material is an anion migration type in which a conductive polymer is doped with an anion during charge, and the anion is dedoped from the polymer during discharge. Therefore, when a carbon material or the like capable of inserting/extracting lithium ions is used as a negative electrode active material, a rocking chair-type secondary battery of cation migration-type in which a cation moves between both electrodes during charge/discharge cannot be constituted. That is, a rocking chair-type secondary battery has the advantage that the required amount of an electrolytic solution is small, but the secondary battery having a conductive polymer as a positive electrode material does not have such an advantage, and therefore cannot contribute to downsizing of power storage devices.

For solving the above-mentioned problems, a cation migration-type secondary battery has also been proposed in which a large amount of an electrolytic solution is not required, the concentration of ions in the electrolytic solution is substantially unchanged, and the capacity density and energy density per volume or weight are thereby improved. In this battery, a positive electrode is constituted using a conductive polymer having as a dopant a polymer anion such as polyvinyl sulfonic acid, and a lithium metal is used for a negative electrode (see JP-A-H01-132052).

When, for example, polyaniline is used as an active material in the secondary battery described above, polyaniline transitions between a doped state and a dedoped state, so that charge-discharge can be performed as a battery. However, polyaniline is easily oxidized in the air, and easily isomerized into a quinonediimine structure. Therefore, polyaniline has been thought to have a problem with storability and handleability, and requires a pretreatment such as a reduction treatment beforehand at the time of actual use.

### SUMMARY OF THE INVENTION

A positive electrode for a power storage device which has an excellent discharge characteristic irrespective of an oxidized state of polyaniline as a positive active material and which is excellent in storability and handleability, and a power storage device using the same are provided.

A power storage device has an excellent discharge characteristic irrespective of an oxidized state of polyaniline as a positive active material and is excellent in storability and handleability. It has been heretofore thought that polyaniline is required to be in a reduced state at the time of use. However, polyaniline in a reduced state is unstable, tends to show a low charge behavior in an initial charge-discharge cycle, and is therefore poor in charge-discharge cycle stability. An oxidation-dedoped state is also concerned in a charge-discharge mechanism of polyaniline, and as a result, it is found that by adjusting the ratio of a polyaniline oxidized body in a positive electrode for a power storage device to a range of 0.01 to 75% to the entire polyaniline, the intended object can be achieved, thus attaining the present invention.

That is, a first aspect is a positive electrode for a power storage device including polyaniline, wherein a ratio of a polyaniline oxidized body in the positive electrode is 0.01 to 75% to the entire polyaniline.

A second aspect is a power storage device including an electrolyte layer; and a positive electrode and a negative electrode that are provided with the electrolyte layer held therebetween, wherein the positive electrode is the positive electrode for a power storage device according to the first aspect.

The positive electrode for a power storage device has an excellent discharge characteristic irrespective of an oxidized state of polyaniline as a positive electrode active material because the ratio of a polyaniline oxidized body in the positive electrode is adjusted to a range of 0.01 to 75% to the entire polyaniline as described above, and a power storage device excellent in storability and handleability can be obtained. That is, by controlling the ratio of the polyaniline oxidized body to be low, a power storage device capable of being fully charged from the initial time and excellent in charge-discharge cycle stability can be obtained. On the other hand, by controlling the ratio of the polyaniline oxidized body to be high, a power storage device excellent in storability and handleability can be obtained.

When the positive electrode for a power storage device contains a binder including an anionic material, and a conductive assistant, the discharge characteristic, storability and handleability are further improved.

When the anionic material is a polyacrylic acid, the discharge characteristic is still further improved.

Further, when the ratio of the polyaniline oxidized body is 0.01 to 20% to the entire polyaniline, the power storage device can be fully charged from the initial time, and is further excellent in charge-discharge cycle characteristic.

When the ratio of the polyaniline oxidized body is 30 to 75% to the entire polyaniline, storability and handleability are still further improved.

### BRIEF DESCRIPTION OF THE DRAWINGS

FIG. 1 is a schematic sectional view showing one example of the power storage device;

FIG. 2 shows a graphical representation of NMR spectra obtained by measuring oxidation type- and reduction type-polyaniline powders by a CP/MS method (the upper half of view shows an oxidation type and the lower half of the view shows a reduction type);

FIG. 3 shows a graphical representation of NMR spectra (thick line) obtained by measuring polyaniline powders different in oxidized state by a DD/MAS method and curve fitting (thin line) of the data thereof;

FIG. 4 shows a graphical representation of FT-IR (infrared) spectra obtained by measuring polyaniline powders different in oxidation degree by a Ge-ATR method (limited to a range of 1400 to 1650 cm⁻¹);

FIG. 5 shows a calibration curve representation in which for polyaniline powders different in oxidation degree, the IR absorbance ratio is on the ordinate and the ratio of an oxidized body is on the abscissa; and

FIG. 6 shows a graphical representation of FT-IR (infrared) spectra obtained by measuring polyaniline in a positive electrode of a power storage device of each of Examples 1 to 4 by a GE-ATR method.

### DETAILED DESCRIPTION OF THE INVENTION

An embodiment of the present invention will be described in detail below, but the descriptions below are one example of embodiments of the present invention, and the present invention is not limited to the descriptions below.

A positive electrode for a power storage device (hereinafter, may be abbreviated simply as a “positive electrode” in some cases) is a positive electrode for a power storage device including polyaniline, wherein a ratio of a polyaniline oxidized body in the positive electrode is 0.01 to 75% to the entire polyaniline.

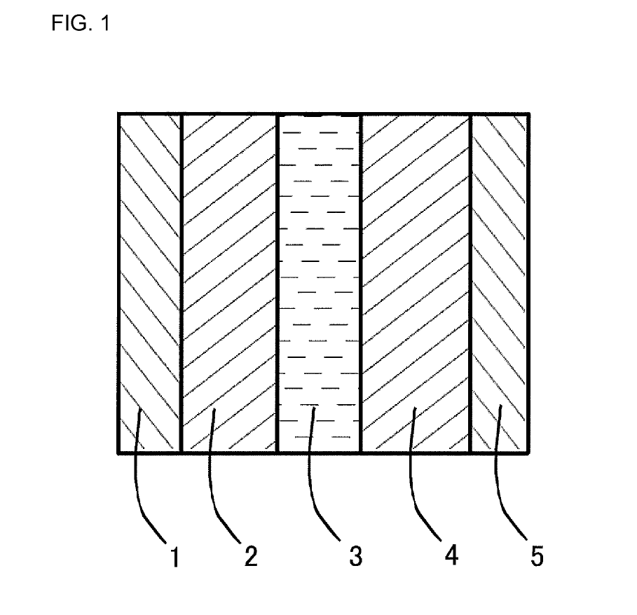

The positive electrode for a power storage device is used, for example, as a positive electrode 2 of a power storage device including an electrolyte layer 3; and the positive electrode 2 and a negative electrode 4 that are provided so as to face each other with the electrolyte layer 3 held therebetween as shown in FIG. 1. In FIG. 1, reference numeral 1 denotes a positive electrode current collector, and reference numeral 5 denotes a negative electrode current collector.

The positive electrode, electrolyte layer and negative electrode will be described in order below.

### <Positive Electrode>

The positive electrode is formed by using a positive electrode forming material such as active material particles containing polyaniline.

### <Polyaniline>

The polyaniline to be used for the positive electrode may be a polyaniline derivative. In the present invention, the polyaniline refers to a polymer obtained by subjecting aniline to electrolytic polymerization or chemical oxidation polymerization, and the polyaniline derivative refers to a polymer obtained by, for example, subjecting a derivative of aniline to electrolytic polymerization or chemical oxidation polymerization.

Examples of the derivative of aniline include those having at least one substituent such as an alkyl group, an alkenyl group, an alkoxy group, an aryl group, an aryloxy group, an alkylaryl group, an arylalkyl group or an alkoxyalkyl group at a position other than the 4-position in aniline. Preferred specific examples thereof include o-substituted anilines such as o-methylaniline, o-ethylaniline, o-phenylaniline, o-methoxyaniline and o-ethoxyaniline; and m-substituted anilines such as m-methylaniline, m-ethylaniline, m-methoxyaniline, m-ethoxyaniline and m-phenylaniline. These derivatives are used alone or in combination of two or more thereof.

Hereinafter, in the present invention, “aniline or a derivative thereof” is referred to simply as “aniline” and “at least one of polyaniline and a polyaniline derivative” is referred to simply as “polyaniline” unless otherwise specified. Therefore, even when a polymer which forms a conductive polymer is obtained from an aniline derivative, the polymer may be referred to as “conductive polyaniline” in some cases.

For the positive electrode forming material, a conductive polymer other than polyaniline may be used in combination with the polyaniline above as long as the object of the present invention is not impaired.

Specific examples of the conductive polymer other than polyaniline include polyacetylene, polypyrrole, polythiophene, polyfuran, polyselenophene, polyisothianaphthene, polyphenylene sulfide, polyphenylene oxide, polyazulene, poly(3,4-ethylenedioxythiophene) and the like.

### <Active Material Particles>

For example, the active material particles can be produced in the following manner. That is, first, polyaniline, i.e., the above-mentioned conductive polymer, and a solvent and other additives etc. as necessary are subjected to a shearing treatment using a crushing and mixing device to obtain the active material particles. Examples of the crushing mixing device include a dry ball mill, a wet ball mill, a bead mill, an attritor, a JET mill fine particle formation device and the like, and preferably a dry ball mill is used.

The diameter of a crushing ball to be used in the ball mill method is preferably 0.1 to 10 mm, further preferably 1 to 7 mm in that a proper shearing treatment can be performed.

The particle diameter (median diameter) of the active material particles is preferably 0.001 to 1000 μm, especially preferably 0.01 to 100 μm, most preferably 0.1 to 20 μm. The median diameter can be measured by a light scattering method using, for example, a dynamic light scattering particle diameter distribution measuring device or the like.

The positive electrode forming material (slurry for a positive electrode) contains the conductive polymer.

In addition to the active material particles, a conductive assistant, a binder and the like can be appropriately added as necessary.

### <Conductive Assistant>

The conductive assistant may be any conductive material as long as its properties are not varied depending on an electric potential applied during discharge of a power storage device, and examples thereof include conductive carbon materials, metal materials and the like, and among them, conductive carbon blacks such as acetylene black and Ketjen black, fibrous carbon materials such as carbon fibers and carbon nanotubes are preferably used, with conductive carbon black being especially preferable.

The compounding amount of the conductive assistant is preferably 1 to 30 parts by weight, further preferably 4 to 20 parts by weight, especially preferably 8 to 18 parts by weight based on 100 parts by weight of the polyaniline.

### <Binder>

Examples of the binder include anionic materials, vinylidene fluoride and the like. These materials are used alone or in combination of two or more thereof. Among them, a binder having an anionic material as a principal component is preferable. Here, the principal component refers to a component constituting more than half of the whole body, and includes a case where the whole body is composed only of a principal component.

Examples of the anionic material include polyanions, anion compounds having a relatively large molecular weight, anion compounds having a low solubility in an electrolytic solution, and the like. More specifically, a compound having a carboxyl group in a molecule is preferably used, and particularly a polycarboxylic acid is preferably used. When a polycarboxylic acid is used as the anionic material, characteristics of a power storage device are improved because the polycarboxylic acid has a function as a binder, and also functions as a dopant.

Examples of the polycarboxylic acid include polyacrylic acid, polymethacrylic acid, polyvinyl benzoic acid, polyallyl benzoic acid, polymethacryl benzoic acid, polymaleic acid, polyfumaric acid, polyglutamic acid, polyaspartic acid and the like. These acids are used alone or in combination of two or more thereof. Among them, polyacrylic acid and polymethacrylic acid are preferable.

Examples of the polycarboxylic acid include those formed by converting to a lithium type a carboxylic acid of a compound having a carboxyl group in a molecule. The conversion rate to the lithium type is preferably 100%, but the conversion rate may be lower according to a situation, and is preferably 40 to 100%.

The anionic material is used in an amount of normally 1 to 100 parts by weight, preferably 2 to 70 parts by weight, most preferably 5 to 40 parts by weight based on 100 parts by weight of the polyaniline. When the amount of the anionic material is excessively small, a power storage device excellent in energy density may not be obtained, and when the amount of the anionic material is excessively large, a power storage device having a high weight energy density may not be obtained.

For example, the positive electrode is formed in the following manner. That is, an anionic material such as the polycarboxylic acid is dissolved in water to form an aqueous solution; thereto are added active material particles containing polyaniline, and a conductive assistant such as conductive carbon black or a binder such as vinylidene fluoride or styrene-butadiene rubber as necessary; the mixture is sufficiently dispersed to prepare a paste; the paste is applied onto a current collector; and water is then evaporated to form a composite having on the current collector a layer of a uniform mixture of the active material particles and the anionic material (and the conductive assistant and the binder as necessary), so that a sheet electrode can be obtained.

the ratio of the polyaniline oxidized body in the positive electrode is 0.01 to 75% to the entire polyaniline, but the ratio of the polyaniline oxidized body is preferably less than 25%, further preferably 20% or less, especially preferably 15% or less, particularly preferably 10% or less in that full discharge can be performed from the initial time. On the other hand, the ratio is preferably 30% or more, further preferably 40% or more, especially preferably 50% or more from the viewpoint of synthesis easiness and storability of polyaniline.

That is, it is preferable that the ratio of the polyaniline oxidized body is in a range of 0.01 to 25% to the entire polyaniline because full discharge can be performed from the initial stage in a charge-discharge cycle, so that the charge-discharge cycle characteristic becomes further excellent. On the other hand, it is preferable that the ratio of the polyaniline oxidized body is in a range of 30 to 75% to the entire polyaniline because in synthesis of polyaniline, a reduction step which has been considered essential heretofore, and a reduction step as a pretreatment at the time of use as a positive electrode material can be omitted, so that storability and handleability become further excellent.

For example, adjustment of the ratio of the polyaniline oxidized body in the positive electrode can be performed by drying a sheet electrode, followed by transferring the sheet electrode to a glove box under a nitrogen atmosphere, and stoichiometrically adjusting the added amount of a reducing agent (e.g., phenylhydrazine) with respect to polyaniline so that the ratio of the polyaniline oxidized body is in a predetermined range (0.01 to 75%). Here, for a reduction reaction of phenylhydrazine as one example of the reducing agent, the following chemical reaction is shown.

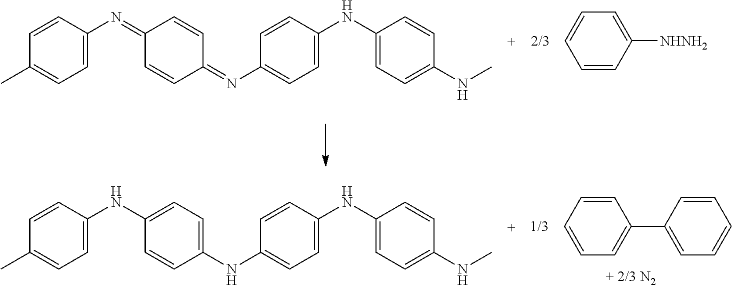

Polyaniline can be similarly subjected to a reduction treatment even in a powder form. However, since the degree of oxidation is increased through various steps during preparation of a sheet electrode, it is preferable to perform adjustment of the degree of oxidation after the preparation of a sheet electrode.

### <Method for Measuring Ratio of Polyaniline Oxidized Body>

For example, the ratio of the polyaniline oxidized body in the positive electrode can be measured in the following manner. That is, a calibration curve is prepared with a solid ¹³CNMR spectrum and a FT-IR (infrared) spectrum measured by a Ge-ATR method, and a ratio of the oxidized body can be determined from the calibration curve.

First, measurement conditions, etc. of the solid ¹³CNMR spectrum (hereinafter, abbreviated as “solid NMR”) spectrum are as follows.

### <Solid NMR Measurement>

Device: AVANCE 300 manufactured by Bruker Biospin Corporation
Observation nuclide: ¹³C
Observation frequency: 75.5 MHz
Measurement method: CP/MAS, DD/MAS
Measurement temperature: room temperature (25° C.)
Chemical Shift standard: glycine (176 ppm)

Methods for measuring solid NMR include a CP/MAS method and a DD/MAS method (CP: Cross Polarization, MAS: Magic Sample Spinning, DD: Dipole Decoupling). The CP/MAS method is not quantitative (detection sensitivity varies for each peak) although the measurement time is short and a strong peak intensity is shown. On the other hand, the DD/MAS measurement is a measurement method which is quantitative although a peak intensity is weak.

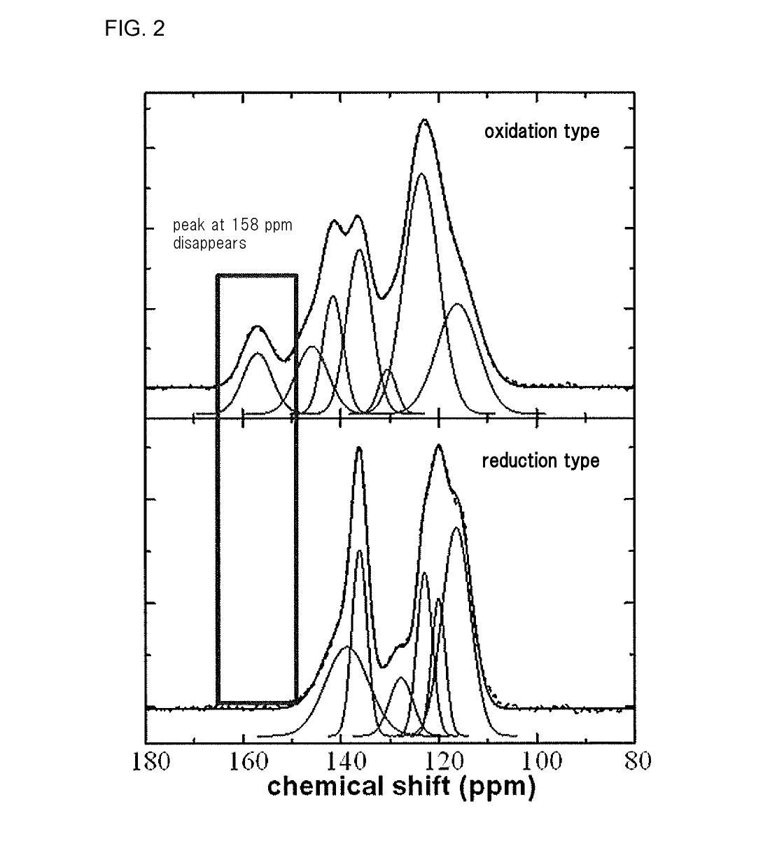

FIG. 2 shows NMR spectra of a polyaniline powder in an oxidation-dedoped state and a polyaniline powder in a reduction-dedoped state which are measured by a CP/MAS method. For the reduction type and the oxidation type of the polyaniline structure, a chemical formula of a part of the structure is shown in the following general formula (1).

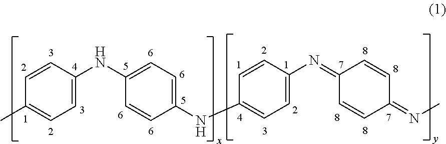

(wherein, x and y are each 0 or a positive number.)

As shown in the above formula (1), the oxidation type of polyaniline has a quinonediimine structure, and the reduction type of polyaniline does not have a quinonediimine structure. Here, from the NMR spectrum obtained by measuring polyaniline by a CP/MAS method in FIG. 2, a peak derived from a quinonediimine structure, i.e., a peak at 158 ppm, exists in the upper view of FIG. 2, but disappears in the lower part of FIG. 2. From this fact, it can be confirmed that the upper view of FIG. 2 where quinonediimine exists corresponds to the oxidation type of polyaniline, and the lower view of FIG. 2 where quinonediimine disappears corresponds to the reduction type of polyaniline.

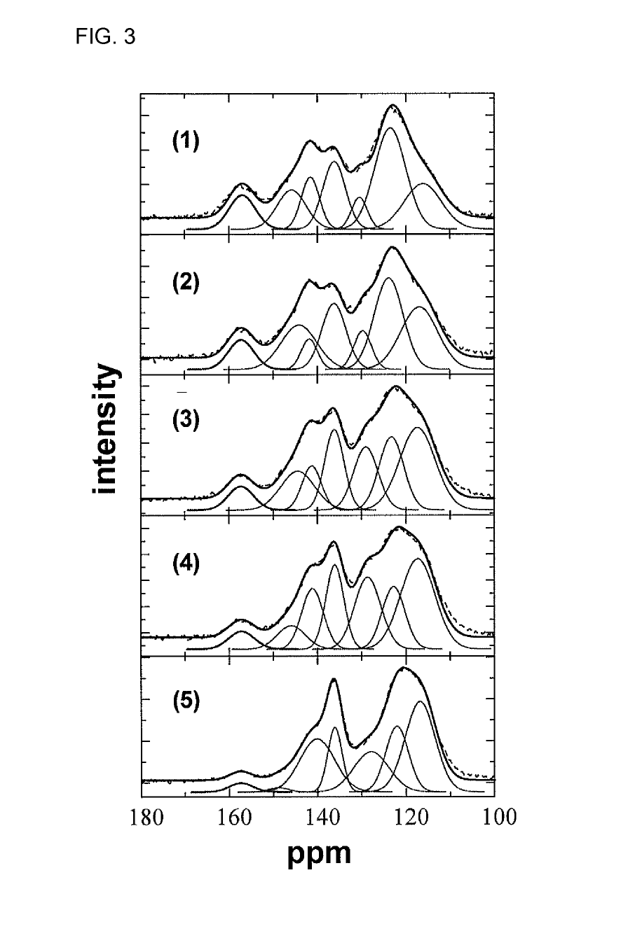

Next, for accurately estimating a ratio of the reduction type and the oxidation type, the ratio of the polyaniline oxidized body was adjusted (e.g., adjusted by the added amount of a reducing agent) to prepare polyanilines (1) to (6) different in oxidized state. Here, for the polyanilines (1) to (5), spectrum measurements were performed by a DD/MAS method. FIG. 3 shows NMR spectra of the polyanilines by a DD/MAS method and results of curve fitting of data thereof. Curve fitting was performed by a method of least squares. The polyaniline (6) is shown in the reduction type in FIG. 2, which is a result of measurement by a CP/MAS method.

Table 1 below shows ratios of areas of peaks at 158 ppm determined from the results of curve fitting of the polyaniline powders (1) to (5) different in oxidized state in FIG. 3, and ratios of results of quantitative determination of the oxidation type/reduction type which are determined from the above-mentioned ratios. The ratios in the polyaniline powder (6) are also shown in Table 1 below, where the peak area ratio is 0 because no peak exists at 158 ppm from the NMR spectrum measured by a CP/MAS method. Although the NMR spectrum measured by a CP/MAS method is not quantitative as described above, the polyaniline powder (6) has no peak at 158 ppm, and therefore it is eventually apparent that the peak area is 0 without necessity to use the quantitative DD/MAS method shown in FIG. 3.

TABLE 1

| | Ratio (%) of the area of | Ratio of the oxidation type/ |
|---|---|---|
| | a peak at 158 ppm to the | reduction type determined from |
| | total area | the area of a peak at 158 ppm |
| (1) | 9.90 | 55/45 |
| (2) | 7.49 | 45/55 |
| (3) | 5.69 | 34/66 |
| (4) | 4.45 | 27/73 |
| (5) | 2.43 | 15/85 |
| (6) | 0 | 0/100 |

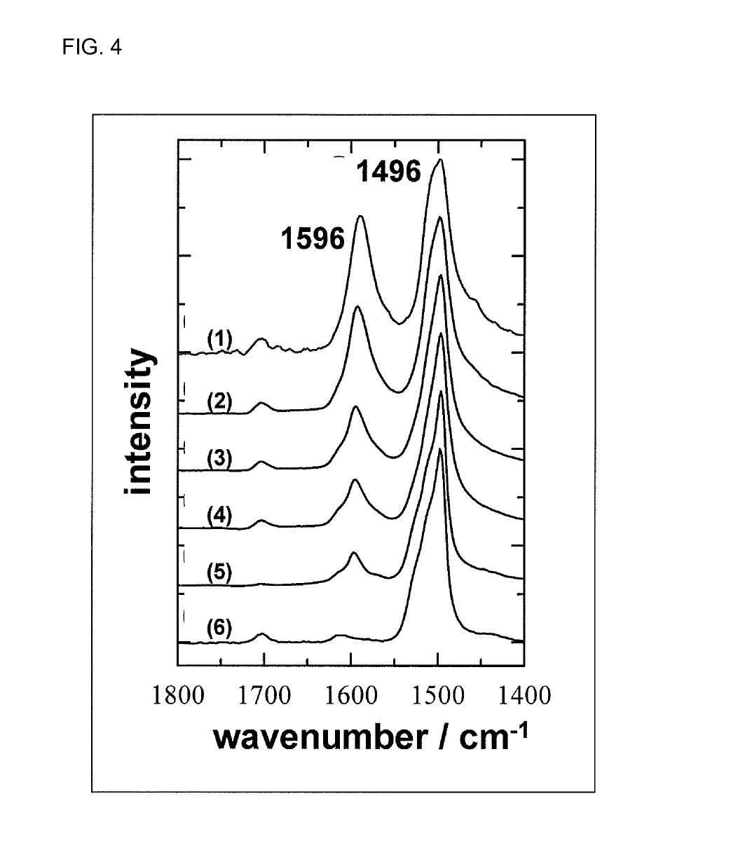

Next, the FT-IR (infrared) spectra of the polyaniline powders (1) to (6) measured by the solid NMR are measured by a Ge-ATR method, and the results thereof are shown in FIG. 4 while being limited within a range of 1400 to 1650 cm⁻¹. The measurement conditions, etc. are as follows.

### <FT-IR (Infrared) Measurement>

Device: Magna 760 manufactured by Thermo Fisher Scientific, Inc.
Measurement mode: one reflection
Incident angle: 45°
IR crystal: Ge
Resolution: 4 cm⁻¹
Measurement range: 4000 to 650 cm⁻¹
Number of integrations: 64

### Detector: DIGS

From FIG. 4, it is apparent that the peak at 1596 cm⁻¹ becomes larger as the ratio of the oxidized body increases. Since generally FT-IR measurement is not quantitative, a calibration curve is prepared together with the results of the measured solid NMR.

### <Preparation of Calibration Curve>

Table 2 below shows the results of ratios of oxidized bodies obtained by solid NMR measurements of the polyaniline powders (1) to (6), and ratios of absorbances at 1596 cm⁻¹/1496 cm⁻¹ which are obtained by FT-IR measurements.

TABLE 2

| | absorbance ratio (1596 | Ratio (%) of |
|---|---|---|
| | cm⁻¹/1496 cm⁻¹) by FT-IR | oxidized body* |
| (1) | 0.65 | 55 |
| (2) | 0.51 | 45 |
| (3) | 0.31 | 34 |
| (4) | 0.24 | 27 |
| (5) | 0.16 | 15 |
| (6) | 0.03 | 0 |

*Values calculated from solid NMR

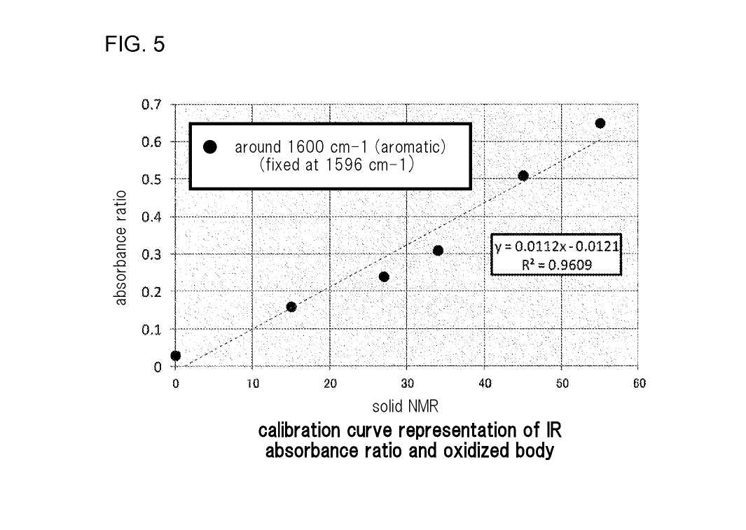

The absorbance ratio described in Table 2 is plotted on the ordinate and the ratio of the oxidized body calculated from solid NMR is plotted on the abscissa to prepare a calibration curve, which is shown in FIG. 5. A ratio of the oxidized body and the reduced body can be conveniently determined by measuring FT-IR using the calibration curve.

The positive electrode is formed into preferably a porous sheet, and the thickness thereof is normally 1 to 500 μm, preferably 10 to 300 μm. The thickness of the positive electrode can be calculated by measuring a thickness using, for example, a dial gage having a tip shape in the form of a flat plate having a diameter of 5 mm (manufactured by OZAKI MFG. CO., LTD.) and determining an average of measured values at 10 points over the surface of the electrode. When a positive electrode (porous layer) is provided on a current collector to form a composite, the thickness of the positive electrode is determined by measuring the thickness of the composite in the same manner as that described above, determining an average of measured values, and subtracting from the value the thickness of the current collector.

### <Electrolyte Layer>

The foregoing electrolyte layer is formed from an electrolyte, and for example, a sheet formed by impregnating a separator with an electrolytic solution or a sheet formed of a solid electrolyte is preferably used. The sheet formed of a solid electrolyte also serves as a separator.

The electrolyte is formed from one containing a solute, and a solvent and various kinds of additives as necessary. As the solute, for example, one formed by combining a metal ion such as a lithium ion with an appropriate counter ion thereto, for example a sulfonic acid ion, a perchloric acid ion, tetrafluoroboric acid ion, a hexafluorophosphoric acid ion, a hexafluoroarsenic ion, a bis(trifluoromethanesulfonyl)imide ion, a bis(pentafluoroethanesulfonyl)imide ion, a halogen ion or the like, is preferably used. Specific examples of the electrolyte may include LiCF₃SO₃, LiClO₄, LiBF₄, LiPF₆, LiAsF₆, LiN(SO₂CF₃)₂, LiN(SO₂C₂F₅)₂, LiCl and the like.

As the solvent, for example, at least one of nonaqueous solvents such as carbonates, nitriles, amides and ethers, i.e., organic solvents, are used. Specific examples of the organic solvents include ethylene carbonate, propylene carbonate, butylene carbonate, dimethyl carbonate, diethyl carbonate, ethylmethyl carbonate, acetonitrile, propionitrile, N,N′-dimethylacetamide, N-methyl-2-pyrrolidone, dimethoxyethane, diethoxyethane, γ-butyrolactone and the like. These solvents are used alone or in combination of two or more thereof. A solution formed by dissolving a solute in the above-described solvent may be referred to as an “electrolytic solution” in some cases.

### <Separator>

the separator can be used in a variety of forms. The separator may be an insulating porous sheet that can prevent an electric short-circuit between a positive electrode and a negative electrode, which are arranged so as to face each other with the separator held therebetween, is electrochemically stable, has high ionic permeability and has mechanical strength to some extent. Therefore, as a material of the separator, for example, paper, a nonwoven fabric, or a porous film formed of a resin of polypropylene, polyethylene, polyimide or the like is preferably used, and these materials are used alone or in combination of two or more thereof.

### <Negative Electrode>

The foregoing negative electrode is preferably one formed by using a negative electrode material (negative electrode active material) capable of inserting/extracting metals or ions. As the negative electrode active material, metal lithium, a carbon material or a transition metal oxide in which lithium ions can be inserted/extracted during oxidation/reduction, silicon, tin or the like is preferably used. Preferably, the thickness of the negative electrode is equivalent to the thickness of the positive electrode.

### <Positive Electrode Current Collector and Negative Electrode Current Collector>

A positive electrode current collector 1 and a negative electrode current collector 5 in FIG. 1 will be described. Examples of the materials of these current collectors include metal foils such as those of nickel, aluminum, stainless steel and copper, meshes, and the like. The positive electrode current collector and the negative electrode current collector may be formed of the same material, or may be formed of different materials.

### <Power Storage Device>

Next, a power storage device using the positive electrode will be described. The power storage device is, for example, one including the electrolyte layer 3, and the positive electrode 2 and the negative electrode 4 which are provided so as to face each other with the electrolyte layer 3 held therebetween as shown in FIG. 1.

For example, the power storage device can be prepared in the following manner by using a material of the negative electrode or the like. That is, the positive electrode and the negative electrode are laminated such that a separator is arranged therebetween, thereby preparing a laminate, and the laminate is placed in a battery container such as an aluminum laminate package, and then the battery container is dried under vacuum. Next, an electrolytic solution is injected into the battery container dried under vacuum, and the package as a battery container is sealed, whereby a power storage device can be prepared. Preferably, preparation of a battery by injection of an electrolytic solution into a package, etc. is performed under an inert gas atmosphere such as ultra-high-purity argon gas in a glove box.

The power storage device is formed into a variety of shapes such as a film shape, a sheet shape, a rectangular shape, a cylindrical shape and button shape besides the laminate cell. As the electrode size of the positive electrode of the power storage device, the length of one side is preferably 1 to 300 mm, especially preferably 10 to 50 mm for the laminate cell, and the electrode size of the negative electrode is 1 to 400 mm, especially preferably 10 to 60 mm. Preferably, the electrode size of the negative electrode is made slightly larger than the electrode size of the positive electrode.

The power storage device is excellent in weight power density and cycle characteristic like an electric double layer capacitor, and has a weight energy density extremely higher than the weight energy density of a conventional electric double layer capacitor. Therefore, the power storage device of the present invention may be a capacitor-like power storage device.

### EXAMPLES

Next, Examples will be described. However, the present invention is not limited to these Examples.

First, components shown below were prepared prior to preparation of a power storage device of Example.

### <Preparation of Conductive Polyaniline Powder Having Tetrafluoroboric Acid as Dopant>

A powder of conductive polyaniline (conductive polymer) having tetrafluoroboric acid as a dopant was prepared in the following manner. That is, 84.0 g (0.402 mol) of an aqueous tetrafluoroboric acid solution at a concentration of 42 wt % (manufactured by Wako Pure Chemical Industries, Ltd., special grade chemical) was added to a glass beaker with a volume of 300 mL, which contained 138 g of ion-exchanged water, and 10.0 g (0.107 mol) of aniline was added thereto while the mixture was stirred by a magnetic stirrer. At the time when aniline was added to the aqueous tetrafluoroboric acid solution, aniline was dispersed as oily liquid droplets in the aqueous tetrafluoroboric acid solution, but subsequently dissolved in water in several minutes to form a homogeneous and clear aqueous aniline solution. The aqueous aniline solution thus obtained was cooled to −4° C. or lower using a low-temperature thermostatic bath.

Next, as an oxidant, 11.63 g (0.134 mol) of a manganese dioxide powder (manufactured by Wako Pure Chemical Industries, Ltd., first grade chemical) was added in the aqueous aniline solution little by little so that the temperature of the mixture in the beaker did not exceed −1° C. When the oxidant was added to the aqueous aniline solution in the manner described above, the aqueous aniline solution immediately turned blackish-green. Thereafter, stirring was continued for a while, and then a blackish-green solid started forming.

After the oxidant was added over 80 minutes in this way, stirring was performed for further 100 minutes while the reaction mixture containing a produced reaction product was cooled. Thereafter, the resulting solid was suction-filtered with No. 2 filter paper using a Buchner funnel and a suction bottle, thereby obtaining a powder. The powder was stirred and washed in an aqueous solution with about 2 mol/L tetrafluoroboric acid using a magnetic stirrer. Then, the powder was stirred and washed with acetone several times, and filtered under reduced pressure. The resulting powder was dried under vacuum at room temperature (25° C.) for 10 hours to obtain 12.5 g of conductive polyaniline having tetrafluoroboric acid as a dopant (hereinafter, referred to simply as “conductive polyaniline”). The conductive aniline was a vivid green powder.

### (Electric Conductivity of Conductive Polyaniline Powder)

The conductive polyaniline powder (130 mg) was crushed by an agate mortar, and subjected to vacuum/press molding under a pressure of 75 MPa for 10 minutes using a unit for molding a KBr tablet for infrared spectrum measurement, thereby obtaining a disc of conductive polyaniline with a thickness of 720 μm. The electric conductivity of the disc as measured by four-terminal method electric conductivity measurement using a van der Pauw method was 19.5 S/cm.

### (Preparation of Conductive Polyaniline Powder in Oxidation-Dedoped State)

The conductive polyaniline powder in a doped state, which was obtained as described above, was put in an aqueous 2 mol/L sodium hydroxide solution, and stirred in a 3 L separable flask for 30 minutes, so that tetrafluoroboric acid as a dopant was dedoped through a neutralization reaction. The dedoped polyaniline was washed with water until the filtrate became neutral, and the polyaniline was then stirred and washed in acetone, and filtered under reduced pressure using a Buchner funnel and a suction bottle, thereby obtaining a dedoped polyaniline powder on No. 2 filter paper. This powder was dried under vacuum at room temperature for 10 hours to obtain a brown polyaniline powder in an oxidation-dedoped state.

This state was defined as that of a nearly complete oxidized body, and this was used for the polyaniline powder of Example 1 described later. The ratio of the oxidized body of the polyaniline powder was 55% to the entire polyaniline.

The oxidized state of the polyaniline powder in an oxidation-dedoped state, which was obtained as described above, was changed by performing the following preparation, and this was used for the polyaniline powders of Examples 2 and 3 described later.

### (Preparation of Polyaniline Powder in Reduction-Dedoped State)

Next, reduction was performed by the following method for changing the oxidized state of the polyaniline powder. The polyaniline powder in an oxidation-dedoped state was put in an aqueous solution of phenylhydrazine in methanol, and subjected to a reduction treatment for 30 minutes under stirring. The color of the polyaniline powder was changed from brown to gray by reduction. After the reaction, the powder was washed with methanol, washed with acetone, filtered, and then dried under vacuum at room temperature to obtain polyaniline in a reduction-dedoped state. The ratio of the oxidized body of the polyaniline powder was 15% to the entire polyaniline. The median diameter of the particles as measured by a light scattering method using acetone as a solvent was 13 μm.

### Example 1

### Battery Prepared Using Electrode Including Polyaniline Oxidized Body at Ratio of 61%

### <Preparation of Binder Solution>

Polyacrylic acid (manufactured by Wako Pure Chemical Industries, Ltd., weight average molecular weight: 1000000) was dissolved in water to obtain 20.5 g of a homogeneous and viscous aqueous polyacrylic acid solution at a concentration of 44 wt %. To this aqueous polyacrylic acid solution was added 0.15 g of lithium hydroxide, and dissolved again to prepare a polyacrylic acid-lithium polyacrylate composite solution with 50% of the acrylic acid moiety replaced by lithium.

### <Preparation of Slurry>

Next, 4 g of the polyaniline powder (oxidized body 55%) in a oxidized state, which was obtained as described above, 0.5 g of a conductive carbon black (DENKA BLACK manufactured by DENKI KAGAKU KOGYO KABUSHIKI KAISHA) powder as a conductive assistant, and 4 g of water were mixed, 20.5 g of the polyacrylic acid-lithium polyacrylate composite solution obtained above was then added thereto, the mixture was well kneaded with a spatula, and then subjected to an ultrasonic treatment for 5 minutes using an ultrasonic homogenizer, and a thin-film spin system high-speed mixer (FILMIX Model 40-40, manufactured by PRIMIX Corporation) was used to obtain a slurry having fluidity. This slurry was degassed for 3 minutes using a planetary centrifugal mixer (THINKY MIXER manufactured (non-vacuum type) by THINKY Co., Ltd.).

### <Preparation of Polyaniline Sheet Electrode>

The slurry was applied onto an etching aluminum foil for an electric double layer capacitor (30CB manufactured by Hohsen Corporation) at an application rate of 10 mm/second us ing a desktop-type automatic coater (manufactured by TESTER SANGYO CO., LTD.) while the coating thickness was adjusted to 360 μm by a doctor blade-type applicator with a micrometer. Next, this was left standing at room temperature (25° C.) for 45 minutes, and then dried on a hot plate at a temperature of 100° C. to prepare a polyaniline sheet electrode.

### <Preparation of Lithium Secondary Battery>

A lithium secondary battery was assembled in the following manner using the polyaniline sheet electrode as a positive electrode and using a nonwoven fabric (TF40-50 manufactured by Hohsen Corporation) as a separator. The positive electrode sheet and the separator were dried under vacuum at 100° C. for 5 hours by a vacuum drier before being assembled into a cell. Metal lithium (manufactured by Honjo Metal Co., Ltd., thickness: 50 μm) was used as a negative electrode, and a solution of lithium tetrafluoroborate (LiBF₄) at a concentration of 1 mol/dm³ in ethylene carbonate/dimethyl carbonate (manufactured by KISHIDA CHEMICAL Co., Ltd.) was used as an electrolytic solution. The lithium secondary battery was assembled under an atmosphere of ultra-high-purity argon gas in a glove box at a dew point of −100° C.

A ratio of a polyaniline oxidized body in the positive electrode is obtained by performing a FT-IR measurement of polyaniline in the positive electrode, and determining the ratio thereof using the aforementioned calibration curve prepared with solid NMR measurement results and FT-IR measurement results obtained by a Ge-ATR method.

The ratio of the polyaniline oxidized body determined as described above was 61%. When the ratio of the oxidized body in the electrode is determined, a spectrum is corrected for suppressing a calculation error caused by electrode components other than polyaniline.

### Example 2

### Battery Prepared Using Electrode Including Polyaniline Oxidized Body at Ratio of 31%

The polyaniline powder in a reduction-dedoped state, which was obtained from the above-described preparation, was subjected to a heating treatment on a hot plate at 80° C. for 3 hours in the air. A battery was prepared in the same method as that in Example 1 except that the polyaniline powder obtained in the manner described above was used in place of the polyaniline powder in an oxidized state (oxidized body 55%) in Example 1.

As a result of determining a ratio of a polyaniline oxidized body in the positive electrode in the same manner as in Example 1, the ratio of the oxidized body was 31% to the entire polyaniline.

### Example 3

### Battery Prepared Using Electrode Including Polyaniline Oxidized Body at Ratio of 28%

A battery was prepared in the same manner as in Example 2 except that the polyaniline powder in a reduction-dedoped state was not subjected to a heating treatment.

As a result of determining a ratio of a polyaniline oxidized body in the positive electrode in the same manner as in Example 1, the ratio of the polyaniline oxidized body was 28% to the entire polyaniline. In Examples 2 and 3, a polyaniline powder in a reduced state was used, but it is thought that the polyaniline powder was oxidized in the process of preparing the polyaniline sheet electrode, so that an electrode containing polyaniline in a highly oxidized state was formed.

### Example 4

### Battery Prepared Using Electrode Including Polyaniline Oxidized Body at Ratio of 6%

A polyaniline sheet electrode prepared in the same manner as in Example 1 was dried, the sheet electrode was then transferred to a glove box under a nitrogen atmosphere, and the electrode in an oxidized state was placed in an aqueous methanol solution, and subjected to a reduction treatment under stirring for 30 minutes using phenylhydrazine in a large excess to polyaniline. After the reaction was completed, the electrode was washed with methanol, washed with acetone, dried in a glove box, then placed in a vacuum sample drier while being held within the glove box, and vacuum-dried in this state at 120° C. for 2 hours. After drying, the electrode was transferred together with the vacuum sample drier to a glove box under an atmosphere of ultra-high-purity argon gas, and a battery was prepared by the same method as that in Example 1.

As a result of determining a ratio of a polyaniline oxidized body in the positive electrode in the same manner as in Example 1, the ratio of the oxidized body was 6% to the entire polyaniline.

For Examples 1 to 4 thus obtained, evaluations and measurements of the items were performed in accordance with the criteria described below. The results thereof are shown in Table 3 described later.

### <<FT-IR Measurement>>

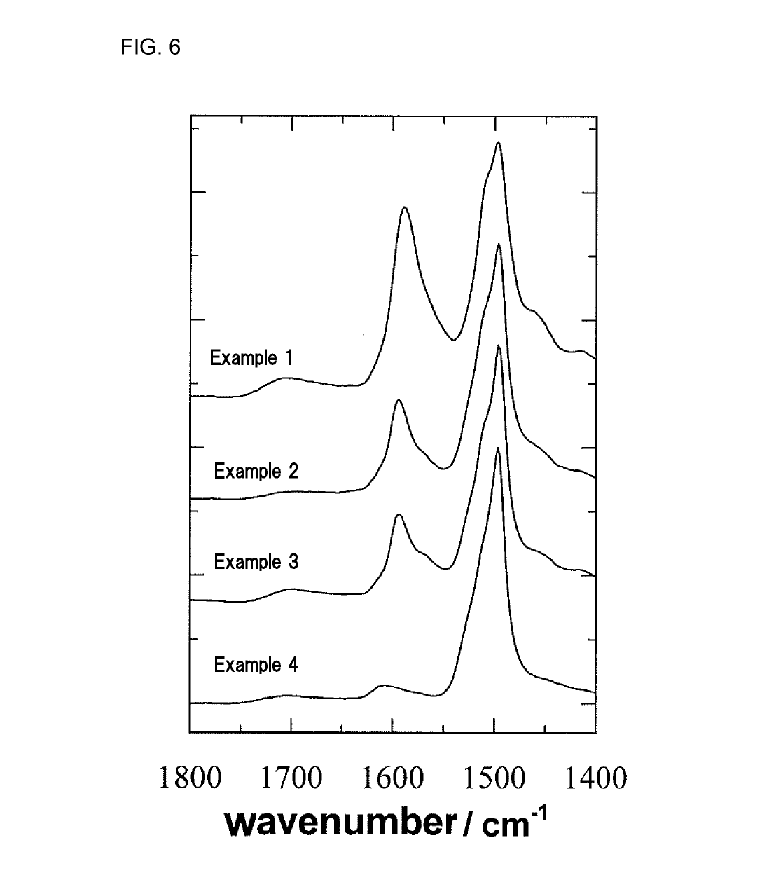

Results of performing a FT-IR measurement obtained by a Ge-ATR method for polyaniline in the positive electrode of each power storage device are shown in FIG. 6. A ratio of a peak at 1596 cm⁻¹ to a peak at 1496 cm⁻¹ (1596 cm⁻¹/1496 cm⁻¹) in FIG. 6 was calculated as absorbance. The results are shown in Table 3 described later. The absorbance from the FT-IR measurement was fitted to the aforementioned calibration curve (FIG. 5) prepared with solid NMR measurement results and FT-IR measurement results obtained by a Ge-ATR method, thereby determining a ratio of a polyaniline oxidized body to the entire polyaniline. The results are also shown in Table 3 described later.

### <<Storability/Handleability>>

Evaluation of the storability/handleability was performed using each power storage device. For the evaluation, those that were not degenerated were rated Very Good, those that were slightly degenerated were rated Good, and those that were easily oxidized and degenerated were rated Not Good.

### <<Charge-Discharge Cycle Stability>>

Evaluation of charge-discharge cycle stability was performed using each power storage device. For the evaluation, those with a small variation in the value of charge-discharge efficiency from the initial stage in the charge-discharge cycle to each cycle were rated Very Good, those with a slight variation in the value from the initial stage until attainment of stabilization were rated Good, and those with a significant variation in the value from the initial stage until attainment of stabilization were rated Not Good.

### <<Weight Capacity Density>>

Each power storage device was placed calmly in a thermostat bath at 25° C., and measured in a constant current-constant voltage charge/constant current discharge mode using a battery charge-discharge device (SD8 manufactured by HOKUTO DENKO CORPORATION). The charge termination voltage was set to 3.8 V, and after the voltage reached 3.8 V through constant current charge, constant voltage charge at 3.8 V was performed until the current value became a value equivalent to 20% with respect to the current value at the time of constant current charge, and the obtained capacity was defined as a charge capacity. Thereafter, constant current discharge was performed to a discharge termination voltage of 2.0 V, and a weight capacity density obtained in the fifth cycle was measured. The weight capacity density shows a value converted as a density per net weight of conductive polyaniline as a positive active material.

### <<Weight Energy Density>>

Each power storage device was measured for the weight energy density in a constant current-constant voltage charge/constant current discharge mode under an environment of 25° C. using a battery charge-discharge device (SD8 manufactured by HOKUTO DENKO CORPORATION). The charge termination voltage was set to 3.8 V, and after the voltage reached 3.8V through constant current charge, constant voltage charge at 3.8 V was performed for 2 minutes, constant current discharge was thereafter performed to a discharge termination voltage of 2.0 V, and a weight energy density was measured. The weight capacity density of polyaniline was set to 150 mAh/g, a total capacity density (mAh/g) was calculated from the amount of polyaniline included in an electrode unit area of each power storage device, and the power storage device was set to perform charge-discharge of the total capacity over 20 hours (0.05 C).

TABLE 3

| | | Ratio (%) | | Charge - | Weight | Weight |
|---|---|---|---|---|---|---|
| | Absorbance | of | | discharge | capacity | energy |
| | ratio of IR | oxidized | Storability/ | cycle | density | density |
| | (1596 cm⁻¹/1496 cm⁻¹) | body | handleability | stability | (mAh/g) | (mWh/g) |
| Example 1 | 0.67 | 61 | Very Good | Not Good | 160 | 512 |
| Example 2 | 0.34 | 31 | Good | Not Good | 152 | 487 |
| Example 3 | 0.3 | 28 | Good | Good | 163 | 521 |
| Example 4 | 0.05 | 6 | Not Good | Very Good | 164 | 526 |

From the results in Table 3, it has become apparent that Examples 1 to 4 are excellent in weight capacity density and weight energy density because they each use a positive electrode in which the ratio of the polyaniline oxidized body is in a range of 0.01 to 75% to the entire polyaniline. It has also become apparent that it is preferable that the ratio of the polyaniline oxidized body is high from the viewpoint of the storability/handleability, while it is preferable that the ratio of the polyaniline oxidized body is low from the viewpoint of charge-discharge cycle stability.

The power storage device of the present invention can be suitably used as a power storage device such as a lithium secondary battery. Further, the power storage device of the present invention can be used for applications similar to those of conventional secondary batteries, and are widely used for, for example, portable electronic devices such as portable personal computers, mobile phones and personal digital assistants (PDAs), and driving power supplies for hybrid electric vehicles, electric vehicles, fuel cell vehicles and the like.

Although specific forms of embodiments of the present invention have been described above and illustrated in the accompanying drawings in order to be more clearly understood, the above description is made by way of example and not as a limitation to the scope of the present invention. It is contemplated that various modifications apparent to one of ordinary skill in the art could be made without departing from the scope of the invention.

What is claimed is:

1. A positive electrode for a power storage device comprising polyaniline, wherein a ratio of a polyaniline oxidized body in the positive electrode is 0.01 to 75% to the entire polyaniline.

2. The positive electrode for a power storage device according to claim 1, which further comprises a binder containing an anionic material, and a conductive assistant.

3. The positive electrode for a power storage device according to claim 2, wherein the anionic material is polyacrylic acid.

4. The positive electrode for a power storage device according to claim 1, wherein the ratio of the polyaniline oxidized body is 0.01 to 25% to the entire polyaniline.

5. The positive electrode for a power storage device according to claim 1, wherein the ratio of the polyaniline oxidized body is 30 to 75% to the entire polyaniline.

6. A power storage device comprising an electrolyte layer, and a positive electrode and a negative electrode that are provided with the electrolyte layer held therebetween, wherein the positive electrode is the positive electrode for a power storage device according to claim 1.
